(19) United States
(12) Patent Application Publication
(10) Pub. No.: US 2006/0159898 A1
(43) Pub. Date: Jul. 20, 2006

(54) Semi-conducting resin composition, and wired circuit board

(75) Inventors: Hisae Uchiyama, Osaka (JP); Naotaka Kinjou, Osaka (JP); Takashi Kondou, Osaka (JP); Takahiro Fukuoka, Osaka (JP); Jun Ishii, Osaka (JP)

Correspondence Address: AKERMAN SENTERFITT, 801 PENNSYLVANIA AVENUE N.W., SUITE 600, WASHINGTON, DC, 20004, US

(73) Assignee: Nitto Denko Corporation, Osaka (JP)

(21) Appl. No.: 11/329,223

(22) Filed: Jan. 11, 2006

(30) Foreign Application Priority Data
Jan. 19, 2005 (JP) JP2005-0011991
May 16, 2005 (JP) JP2005-142815

(51) Int. Cl. C08F 8/00; B32B 3/00

(52) U.S. Cl. 428/209; 525/55

(57) ABSTRACT

To provide a semi-conducting resin composition capable of forming a semi-conducting layer which exhibits a less variable surface resistivity even when subjected to ultrasonic cleaning and effectively discharges static electricity and also provide a wired circuit board comprising the semi-conducting layer composed of the semi-conducting resin composition, an imide resin or a precursor of an imide resin and conducting particles are mixed in a solvent so that the semi-conducting resin composition containing the imide resin or imide resin precursor dissolved therein and the conducting particles dispersed therein is prepared. Then, the semi-conducting resin composition is coated on a surface of an insulating cover layer (5) including the terminal portion (6) of a suspension board with circuit (1) and dried to form a semi-conducting layer (7). Thereafter, the semi-conducting layer 7 formed in the terminal portion (6) is removed by etching.

### CROSS REFERENCE TO RELATED APPLICATION

This application claims priority from Japanese Patent Application No. 2005-011991, filed on Jan. 19, 2005 and Japanese Patent Application No. 2005-142815 filed on May 16, 2005, the contents of which are herein incorporated by reference in their entirety.

### BACKGROUND OF THE INVENTION

1. Field of the Invention

The present invention relates to a semi-conducting resin composition and to a wired circuit board. More particularly, the present invention relates to a wired circuit board to be provided in electric/electronic equipment and to a semi-conducting resin composition for forming a semi-conducting layer in the wired circuit board.

2. Description of Related Art

A wired circuit board, such as a flexible wired circuit board or a suspension board with circuit, typically comprises: a base layer composed of polyimide; a conductive circuit composed of copper foil formed on the base layer; and a cover layer composed of polyimide formed over the base layer and the conductive circuit. The wired circuit board with electronic components mounted thereon is incorporated in various electric/electronic equipment.

To prevent electrostatic discharge in electronic components mounted on such a wired circuit board, an approach has been proposed which forms a conducting polymer layer on the cover layer and discharges static electricity via the conducting polymer layer (see, e.g., Japanese Laid-Open (Unexamined) Patent Publication No. 2004-158480).

In the manufacturing of a wired circuit board, ultrasonic cleaning is normally performed in the final step thereof to remove a foreign material adhered to a surface of the wired circuit board including terminal portions for mounting electronic components. When ultrasonic cleaning is performed, however, the problem is encountered that the surface resistivity of the conducting polymer layer varies to disable effective discharge of static electricity.

### SUMMARY OF THE INVENTION

It is therefore an object of the present invention to provide a semi-conducting resin composition capable of forming a semi-conducting layer which exhibits a less variable surface resistivity even when subjected to ultrasonic cleaning and effectively discharges static electricity and also provide a wired circuit board including the semi-conducting layer composed of the semi-conducting resin composition.

A semi-conducting resin composition according to the present invention comprises an imide resin or a precursor of an imide resin, a conducting particle, and a solvent.

In the semi-conducting resin composition according the present invention, the conducting particle is preferably at least one selected from the group consisting of a carbon black particle, a carbon nanofiber, and a metal oxide particle.

Preferably, the semi-conducting resin composition according to the present invention further comprises a sensitizer.

A wired circuit board according to the present invention comprises: a conductive layer; an insulating layer adjacent to the conductive layer; and a semi-conducting layer composed of a semi-conducting resin composition comprising an imide resin or a precursor of an imide resin, a conducting particle, and a solvent, the semi-conducting layer being formed on a surface of the insulating layer.

The semi-conducting layer formed from the semi-conducting resin composition according to the present invention exhibits a less variable surface resistivity even when it is subjected to ultrasonic cleaning so that it allows effective discharge of static electricity. Accordingly, the wired circuit board including such a semi-conducting layer according to the present invention allows reliable prevention of electrostatic discharge in electronic components mounted thereon by effectively discharging static electricity, while removing a foreign material by ultrasonic cleaning to improve connection reliability.

### BRIEF DESCRIPTION OF THE DRAWINGS

FIG. 1 illustrates an embodiment of the steps of forming a semi-conducting layer in a suspension board with circuit as an embodiment of a wired circuit board according to the present invention, of which:

FIG. 1(a) illustrates the step of preparing the suspension board with circuit;

FIG. 1(b) illustrates the step of forming the semi-conducting layer on a surface of an insulating cover layer including a surface of a terminal portion;

FIG. 1(c) illustrates the step of covering the surface of the insulating cover layer except for the terminal portion with an etching resist;

FIG. 1(d) illustrates the step of removing the semi-conducting layer which is exposed from the etching resist; and

FIG. 1(e) illustrates the step of removing the etching resist,

FIG. 2 illustrates another embodiment of the steps of forming the semi-conducting layer on the suspension board with circuit as the embodiment of the wired circuit board according to the present invention, of which:

FIG. 2(a) illustrates the step of preparing the suspension board with circuit;

FIG. 2(b) illustrates the step of forming a coating composed of a semi-conducting resin composition containing a sensitizer added thereto on the surface of the insulating cover layer including that of the terminal portion;

FIG. 2(c) illustrates the step of optically exposing the coating through a photo-mask;

FIG. 2(d) illustrates the step of removing the portion of the semi-conducting layer which corresponds to the terminal portion by development; and

FIG. 2(e) illustrates the step of curing (imidizing) a precursor of an imide resin, and

FIG. 3 is a cross-sectional view showing a single-sided flexible wired circuit board as another embodiment of the wired circuit board according to the present invention.

### DESCRIPTION OF THE PREFERRED EMBODIMENTS

A semi-conducting resin composition according to the present invention contains an imide resin or a precursor of an imide resin, conducting particles, and a solvent.

Examples of the imide resin according to the present invention include polyimide, polyether-imide, and polyamide-imide which are commercially available. Examples of commercially available polyimide include PI-113, PI-117, PI-213B (which are commercially available from Maruzen Petrochemical Co., Ltd.), and RIKACOAT-20™ (which is commercially available from New Japan Chemical Co., Ltd.). Examples of commercially available polyether-imide include Ultem 1000™ and Ultem XH6050™ (which are commercially available from GE Plastics Japan, Ltd.). Examples of commercially available polyamide-imide include HR16NN™ and HR11NN™ (which are commercially available from Toyobo. Co., Ltd.).

Examples of the imide resin precursor include a polyamic acid resin. The polyamic acid resin can be produced normally by reacting organic tetracarboxylic dianhydride with diamine.

Examples of the organic tetracarboxylic dianhydride include pyromelletic dianhydride, 3,3′,4,4′-biphenyltetracarboxylic dianhydride, 2,2-bis(2,3-dicarboxyphenyl)-1,1,1,3,3,3-hexafluoropropane dianhydride, 2,2-bis(3,4-dicarboxyphenyl)-1,1,1,3,3,3-hexafluoropropane dianhydride, 3,3′4,4′-benzophenonetetracarboxylic dianhydride, bis(3,4-dicarboxyphenyl)-ether dianhydride, and bis(3,4-dicarboxyphenyl)-sulfonic dianhydride. These may be used either singly or in a combination of two or more.

Examples of the diamine include m-phenylenediamine, p-phenylenediamine, 3,4′-diaminodiphenyl ether, 4,4′-diaminodiphenyl ether, 4,4′-diaminodiphenyl sulfone, 3,3′-diaminodiphenyl sulfone, 2,2-bis(4-aminophenoxyphenyl)propane, 2,2-bis(4-aminophenoxyphenyl) hexafluoropropane, 1,3-bis(4-aminophenoxy)benzene, 1,4-bis(4-aminophenoxy)benzene, 2,4-diaminotoluene, 2,6-diaminotoluene, diaminodiphenylmethane, 4,4′-diamino-2,2-dimethylbiphenyl, and 2,2-bis(trifluoromethyl)-4,4′-diaminobiphenyl. These may be used either singly or in a combination of two or more.

The polyamic acid resin can be obtained as a solution of a polyamic acid resin by reacting the organic tetracarboxylic dianhydride with the diamine at such a ratio as to provide a substantially equimolecular ratio in an appropriate organic solvent, e.g., a non-protonic polar solvent such as N-methyl-2-pyrrolidone, N,N-dimethylacetamide, N,N-dimethylformamide, or dimethylsulfoxide normally at 0-90° C. for 1 to 24 hours. The polyamic acid resin has a weight-average molecular weight in an approximate range of, e.g., 5,000 to 200,000 or preferably 10,000 to 100,000.

Examples of the conducting particles used in the present invention include, e.g., particles of carbon black, a carbon nanofiber, particles of a metal oxide such as particles of a composite oxide of indium and tin (ITO particles) or a composite oxide of tin and phosphorous (PTO particles). The conducting particles can be used either singly or in a combination of two or more. Preferably, either of the carbon black and the carbon nanofiber is used to compose the conducting particles. The conducting particles have an average particle size in the range of, e.g., 10 nm to 1 μm, preferably 10 nm to 400 nm, or more preferably 10 nm to 100 nm. In the case where the conducting particles are composed of a carbon nanofiber, the diameters thereof range from 100 to 200 nm and the lengths thereof range from 5 to 20 μm. When the average particle size is smaller than the first one of the ranges listed above, the adjustment of the average particle size (diameter) may occasionally be difficult. Conversely, when the average particle size is larger than the first range, the conducting particles may occasionally be unsuitable for use in the coating of the semi-conducting resin composition.

The solvent used in the present invention is not particularly limited as long as the imide resin or the imide resin precursor can be dissolved therein and the conducting particles can be dispersed therein. Examples of the solvent include a non-protonic polar solvent such as N-methyl-2-pyrrolidone (NMP), N,N-dimethylacetamide, N,N-dimethylformamide, or dimethylsulfoxide. These solvents can be used either singly or in a combination of two or more. In the case where the polyamic acid resin is used as the imide resin or the imide resin precursor, a reaction solvent for dissolving the polyamic acid resin can be used directly as a solvent for the semi-conducting resin composition without any alteration.

By mixing the imide resin or the imide resin precursor, the conducting particles, and the solvent with each other, the semi-conducting resin composition according to the present invention can be prepared.

The mixing ratio of the conducting particles to the imide resin or the imide resin precursor is such that, e.g., 3 to 300 parts or preferably 5 to 250 parts by weight of the conducting particles are mixed with 100 parts by weight of the imide resin or the imide resin precursor. When the mixing ratio of the conducting particles to the imide resin or the imide resin precursor is lower than the former one of the ranges listed above, the surface resistivity may occasionally be higher than 10¹¹ Ω/□. Conversely, when the mixing ratio of the conducting particles to the imide resin or the imide resin precursor is higher than the former range, the surface resistivity may occasionally be lower than 10⁵ Ω/□. The solvent is mixed such that the imide resin or the imide resin precursor and the conducting particles range from 5 to 40% or preferably from 10 to 30% by weight (in solids concentration) relative to the semi-conducting resin composition. When the solids concentration is lower than the former one of the ranges listed above, uniform coating of the semi-conducting resin composition may occasionally be difficult. Conversely, when the solids concentration is higher than the former range, the dispersibility of the conducting particles in the solvent may be degraded occasionally.

The preparation of the semi-conducting resin composition is not particularly limited. For example, the imide resin or the imide resin precursor and the conducting particles may be mixed appropriately in the solvent and blended with stirring until the imide resin or the imide resin precursor are evenly dissolved in the solvent and the conducting particles are evenly dispersed therein. Alternatively, it is also possible to blend a resin solution obtained by preliminarily dissolving the imide resin or the imide resin precursor in a solvent with a particle dispersion obtained by preliminarily dispersing the conducting particles in a solvent. As a result, the semi-conducting resin composition is prepared which contains the imide resin or the imide resin precursor dissolved in the solvent and the conducting particles dispersed therein.

By coating, drying, and, if necessary, curing the semi-conducting resin composition thus obtained according to the present invention, the semi-conducting layer can be formed. Since the formed semi-conducting layer exhibits a less variable surface resistivity even when it is subjected to ultrasonic cleaning, static electricity can be discharged effectively.

By forming such a semi-conducting layer on a wired circuit board, it becomes therefore possible to obtain a wired circuit board which allows reliable prevention of electrostatic discharge in electronic components mounted thereon by effectively discharging static electricity, while removing a foreign material by ultrasonic cleaning to improve connection reliability.

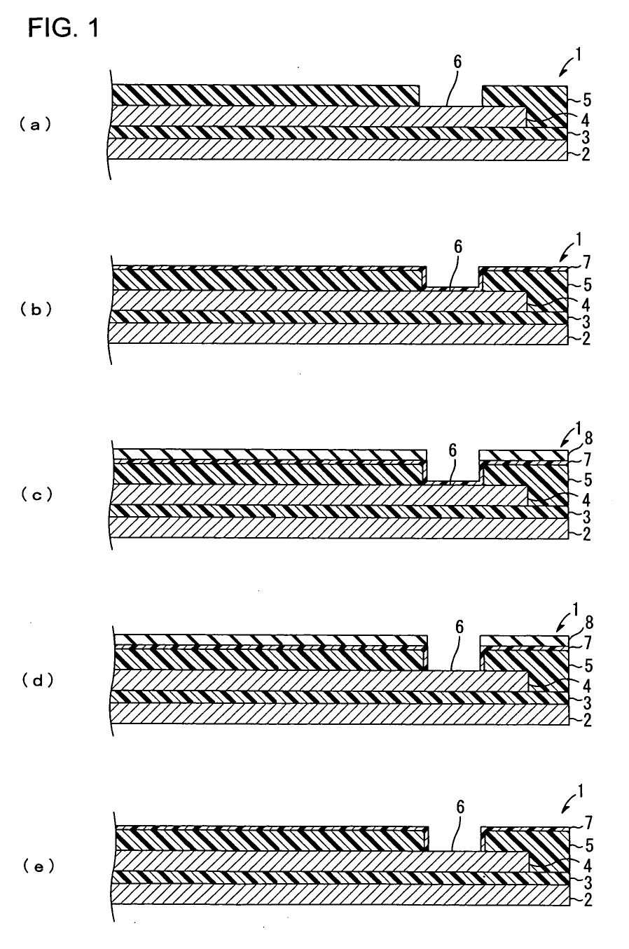

FIG. 1 illustrates the steps of forming a semi-conducting layer on a suspension board with circuit as an embodiment of the wired circuit board according to the present invention. Referring to FIG. 1, a description will be given next to a method of forming the semi-conducting layer on the suspension board with circuit.

First, as shown in FIG. 1(a), the method prepares a suspension board with circuit 1. The suspension board with circuit 1 comprises: a metal supporting board 2; an insulating base layer 3 formed on the metal supporting board 2; a conductive pattern 4 formed as a conductive layer on the insulating base layer 3; and an insulating cover layer 5 formed on the insulating base layer 3 to cover the conductive pattern 4.

The metal supporting board 2 is composed of, e.g., stainless steel foil, 42-alloy foil, aluminum foil, copper-beryllium foil, phosphor bronze foil, or the like. The metal supporting board 2 has a thickness in the range of, e.g., 5 to 100 μm.

The insulating base layer 3 is formed from a synthetic resin such as polyimide, polyamide-imide, acryl, polyethernitrile, polyethersulfone, polyethylene terephthalate, polyethylene naphthalate, or polyvinyl chloride. Preferably, the insulating base layer 3 is composed of polyimide resin. The insulating base layer 3 has a thickness in the range of, e.g., 5 to 50 μm.

The conductive pattern 4 is composed of, e.g., copper foil, nickel foil, gold foil, solder foil, or alloy foil thereof and formed as a pattern composed of a plurality of wires. The conductive pattern 4 has a thickness in the range of, e.g., 3 to 50 μm.

The insulating cover layer 5 is composed of the same synthetic resin as used to compose the insulating base layer 3. The insulating cover layer 5 has a thickness in the range of, e.g., 3 to 50 μm

The suspension board with circuit 1 has terminal portions 6 for mounting various electronic components, such as a magnetic head, each of which is formed as the exposed portion of the conductive pattern 4 by forming an opening in the insulating cover layer 5 and exposing the conductive pattern 4 therethrough.

Then, as shown in FIG. 1(b), the method forms a semi-conducting layer 7 on a surface of the insulating cover layer 5 including a surface of the terminal portion 6. The formation of the semi-conducting layer 7 is initiated by evenly coating the foregoing semi-conducting resin composition on the surface of the insulating cover layer 5 including that of the terminal portion 6. The coating of the semi-conducting resin composition is not particularly limited. For example, a known coating method such as roll coating, gravure coating, spin coating, or bar coating is used for the coating thereof. Then, the coated semi-conducting resin composition is dried. The drying of the semi-conducting resin composition is performed at a temperature in the range of, e.g., 60 to 250° C. or preferably 80 to 200° C. for, e.g., 1 to 30 minutes or preferably 3 to 15 minutes, though the drying conditions are determined appropriately depending on the type of the solvent. When the drying time is shorter than the former one of the ranges listed above, the surface resistivity of the semi-conducting layer 7 may occasionally vary greatly due to insufficient removal of the solvent. Conversely, when the drying time is longer than the former range, production efficiency may be degraded occasionally.

In the case where the semi-conducting resin composition contains the imide resin precursor, the heating of the imide resin precursor is performed at a temperature of 250° C. or more under reduced pressure after drying, thereby curing (imidizing) the imide resin precursor. The semi-conducting layer 7 has a thickness in the range of, e.g., 0.5 to 5 μm or preferably 0.5 to 2 μm. When the thickness of the semi-conducting layer 7 is smaller than the former one of the ranges listed above, a uniform layer may not be formed occasionally. Conversely, when the thickness thereof is larger than the former range, drying may be insufficient and cost may be increased occasionally.

The semi-conducting layer 7 has a surface resistivity in the range of, e.g., 10⁵ to 10¹¹ Ω/□ or preferably 10⁶ to 10¹⁰ Ω/□. When the surface resistivity of the semi-conducting layer 7 is lower than the former one of the ranges listed above, the mounted electronic components may incur occasional misoperation. Conversely, when the surface resistivity thereof is higher than the former range, effective discharge of static electricity may not be performed occasionally.

The surface resistivity of the semi-conducting layer 7 can be measured by using, e.g., Hiresta IP MCP-HT260™ (Probe: HRS) commercially available from MITSUBISHI PETROCHEMICAL Co., Ltd.

Then, as shown in FIG. 1(c), the method covers a surface of the semi-conducting layer 7 except for the terminal portion 6 with an etching resist 8. The etching resist 8 is formed by, e.g., a known method which deposits a layer of a dry-film photo-resist on the surface of the semi-conducting layer 7 and subsequently performs optical exposure and development.

Then, as shown in FIG. 1(d), the method removes the portion of the semi-conducting layer 7 which is formed on the surface of the terminal portion 6 exposed through the etching resist 8 by etching. As an etchant, an aqueous alkaline solution such as an aqueous potassium hydroxide solution is used and wet etching is performed by immersion or spraying.

Then, as shown in FIG. 1(e), the method removes the etching resist by etching or releasing.

By the foregoing steps, the semi-conducting layer 7 is formed on the surface of the insulating cover layer 5 except for that of the terminal portion 6 (though the semi-conducting layer 7 is formed on the inner circumferential side surface of the insulating cover layer 5 surrounding the terminal portion 6 and on the peripheral portion of the terminal portion 6).

Thereafter, a plating layer composed of gold or nickel is formed as necessary on the surface of the terminal portion 6 by electrolytic plating or non-electrolytic plating.

In the final step, the method performs ultrasonic cleaning to remove a foreign material adhered to the surface of the suspension board with circuit 1 including the exposed terminal portion 6. The ultrasonic cleaning also allows the formation of the semi-conducting layer 7 exhibiting a less variable surface resistivity and effective discharge of static electricity. Accordingly, the suspension board with circuit 1 allows reliable prevention of electrostatic discharge in various electronic components mounted thereon, such as a magnetic head, by effectively discharging static electricity, while removing a foreign material by ultrasonic cleaning to improve connection reliability.

The semi-conducting resin composition according to the present invention can further contain a sensitizer. Examples of the sensitizer include derivatives of dihydropyridine such as 4-o-nitrophenyl-3,5-dimethoxycarbonyl-2,6-dimethyl-1,4-dihydropyridine (nifedipine), 4-o-nitrophenyl-3,5-dimethoxycarbonyl-2,6-dimethyl-1-methyl-4-hydropyridine (N-methyl compound), and 4-o-nitrophenyl-3,5-diacetyl- 1,4-dihydropyridine (acetylated compound). These sensitizers may be used either singly or in a combination of two or more. The sensitizer can also be prepared as a solution by dissolving it in a solvent such as, e.g., polyethylene glycol.

The sensitizer is mixed together with the imide resin or the imide resin precursor described above and the conducting particles in the solvent. The mixing ratio of the sensitizer to the imide resin or the imide resin precursor is such that, e.g., 0.1 to 100 parts or preferably 0.5 to 75 parts by weight of the sensitizer are mixed with 100 parts by weight of the imide resin or the imide resin precursor. When the mixing ratio of the sensitizer to the imide resin or the imide resin precursor is either higher or lower than the former one of the ranges listed above, a proper dissolution speed difference cannot be obtained between an optically exposed portion and an optically unexposed portion, which makes patterning occasionally difficult. Even when the sensitizer is mixed, the solvent is mixed such that the imide resin or the imide resin precursor, the conducting particles, and the sensitizer range from 5 to 30% or preferably 5 to 20% by weight (in solids concentration) relative to semi-conducting resin composition.

In the case where the sensitizer is added, the imide resin precursor is used preferably as the imide resin or the imide resin precursor described above.

Since the sensitizer has been added to the foregoing semi-conducting resin composition thus obtained, the semi-conducting layer 7 can be formed in a specified pattern by coating, drying, optically exposing, and developing the semi-conducting resin composition and curing it if necessary.

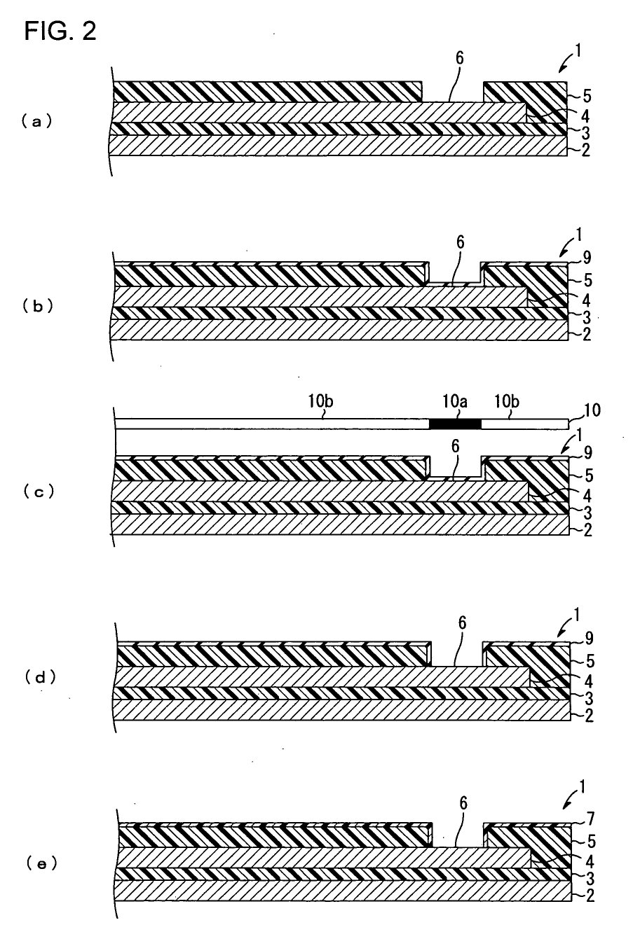

FIG. 2 illustrates another embodiment of the steps of forming the semi-conducting layer on the suspension board with circuit as the embodiment of the wired circuit board according to the present invention. Referring to FIG. 2, a description will be given next to a method of forming the semi-conducting layer in a specified pattern on the suspension board with circuit by using the semi-conducting resin composition containing the sensitizer added thereto.

First, as shown in FIG. 2(a), the method prepares the suspension board with circuit 1 in the same manner as described above.

Then, as shown in FIG. 2(b), the method forms a coating 9 composed of the semi-conducting resin composition containing the added sensitizer on the surface of the insulating cover layer 5 including that of the terminal portion 6. The formation of the coating 9 is initiated by evenly coating the semi-conducting resin composition containing the sensitizer on the surface of the insulating cover layer 5 including that of the terminal portion 6 in the same manner as described above. Subsequently, the coated semi-conducting resin composition is dried in the same manner as described above.

Then, as shown in FIG. 2(c), the method optically exposes the coating 9 through a photo-mask 10. The photo-mask 10 includes a light shielding portion 10a which does not transmit light and a light transmitting portion 10b which transmits light in a specified pattern. In the case where patterning is performed with a negative image, the photo-mask 10 is placed such that the light shielding portion 10a is opposed to the portion of the coating 9 in which the semi-conducting layer 7 is not formed, including the terminal portion 6, and the light transmitting portion 10b is opposed to the other portion thereof in which the semi-conducting layer 7 is formed, as shown in FIG. 2(c), and then optical exposure is performed.

If necessary, heating is performed subsequently at a specified temperature for forming the negative image and then, as shown in FIG. 2(d), the optically unexposed portion of the semi-conducting layer 7 that has been opposed to the light shielding portion 10a, i.e., the portion of the semi-conducting layer 7 which corresponds to the terminal portion 6 is removed by development. The development is performed by a method using an aqueous alkaline solution as a developer, such as immersion or spraying. As a result, the coating 9 is formed in a specified pattern on the surface of the insulating cover layer 5 except for the terminal portion 6.

In the case where patterning is performed with a positive image, optical exposure is performed by switching the positions of the light shielding portion 10a and the light transmitting portion 10b in the photo-mask 10, i.e., opposing the light transmitting portion 10b to the terminal portion 6. If necessary, heating is performed subsequently at a specified temperature for forming the positive image, which is followed by development.

In the case where the semi-conducting resin composition contains the imide resin precursor, the method then heats the imide resin precursor at a temperature of, e.g., 250° C. or more under reduced pressure, thereby curing (imidizing) the semi-conducting resin composition, as shown in FIG. 2(e).

By the foregoing steps, the semi-conducting layer 7 is formed on the surface of the insulating cover layer 5 except for the surface of the terminal portion 6 (though the semi-conducting layer 7 is formed on the inner circumferential side surface of the insulating cover layer 5 surrounding the terminal portion 6 and on the peripheral portion of the terminal portion 6) in the same manner as described above. The thickness and surface resistivity of the semi-conducting layer 7 are the same as described above.

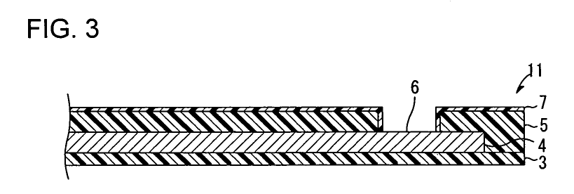

Although the foregoing description has been given by using the suspension board with circuit 1 as an example of the wired circuit board according to the present invention, examples of the wired circuit board according to the present invention also include a single-sided flexible wired circuit board, a double-sided flexible wired circuit board, a multilayer flexible wired circuit board, and the like. For example, as shown in FIG. 3, the insulating base layer 3, the conductive pattern 4, and the insulating cover layer 5 are formed successively in the single-sided flexible wired circuit board 11 and the exposed portion of the conductive pattern 4 is formed as the terminal portion 6 by forming an opening in the insulating cover layer 5. Then, the semi-conducting layer 7 is formed on the surface of the insulating cover layer 5 except for that of the terminal 6 (though the semi-conducting layer 7 is formed on the inner circumferential side surface of the insulating cover layer 5 surrounding the terminal portion 6 and on the peripheral portion of the terminal portion 6). Alternatively, the semi-conducting layer 7 may be formed in the insulating base layer 3 depending on the purpose and application thereof. The semi-conducting layer 7 may also be formed in each of the insulating base layer 3 and the insulating cover layer 5.

The semi-conducting layer 7 may also be formed either as a single layer or as multiple layers. In the case where the semi-conducting layer 7 is formed as multiple layers, each of the multiple semi-conducting layers 7 is formed such that the conducting particles contained therein have a mixing ratio which gradually decreases with distance from the insulating cover layer 5.

### EXAMPLES

The present invention will be described more specifically by way of the following examples. However, the present invention is in no way limited to the examples.

### Example 1

A suspension board with circuit was prepared by successively forming an insulating base layer composed of polyimide, a conductive pattern composed of copper foil, and an insulating cover layer composed of polyimide on a metal supporting board composed of stainless steel foil (see FIG. 1(a)). The opening was formed in the insulating cover layer so that the portion of the conductive pattern which was exposed through the opening serves as the terminal portion.

15 g of a 10 wt % N-methyl-2-pyrrolidone (NMP) dispersion of carbon black (Special Black4™ commercially available from Degussa Japan, Ltd.) was added to 20 g of a 15 wt % NMP solution of polyether-imide (HR16NN™ commercially available from Toyobo. Co., Ltd.). The resulting mixture was stirred to provide a semi-conducting resin composition.

The semi-conducting resin composition was coated on the surface of the insulating cover layer including the terminal portion of the suspension board with circuit described above by using a bar coater, dried at 100° C. for 5 minutes, and further dried at 180° C. for 15 minutes, thereby forming a semi-conducting layer with a thickness of 2 μm (see FIG. 1(b)).

Then, the surface of the insulating cover layer except for the terminal portion was covered with an etching resist (see FIG. 1(c)) and the portion of the semi-conducting layer which was formed on the surface of the terminal portion exposed through the etching resist was removed by etching using an aqueous potassium hydroxide solution as an etchant (see FIG. 1(d)). Thereafter, the etching resist was released by using an aqueous sodium hydroxide solution as a releasant (see FIG. 1(e)), whereby the suspension board with circuit in which the semi-conducting layer was formed on the surface of the insulating cover layer except for that of the terminal portion was obtained.

The initial surface resistivity of the semi-conducting layer was 10⁸ Ω/□.

### Example 2

22.3 g of a 19.9 wt % NMP dispersion of ITO particles (commercially available from Catalysts & Chemicals Industries Co., Ltd.) was added to 7 g of a 40 wt % NMP solution of polyether-imide (Ultem XH6050™ commercially available from GE Plastics Japan, Ltd.). The resulting mixture was stirred to provide a semi-conducting resin composition.

The semi-conducting resin composition was coated on the surface of the insulating cover layer including the terminal portion of a suspension board with circuit, which is the same as used in Example 1, by using a bar coater, dried at 100° C. for 5 minutes, and further dried at 180° C. for 15 minutes, thereby forming a semi-conducting layer with a thickness of 1 μm.

Subsequently, the same process steps as performed in Example 1 were performed, whereby the suspension board with circuit in which the semi-conducting layer was formed on the surface of the insulating cover layer except for that of the terminal portion was obtained.

The initial surface resistivity of the semi-conducting layer was 2.9×10⁸ Ω/□.

### Example 3

3.1 g of a 20.6 wt % NMP dispersion of PTO particles (commercially available from Catalysts & Chemicals Industries Co., Ltd.) was added to 2 g of a 15 wt % NMP solution of polyether-imide (HR16NN™ commercially available from Toyobo. Co., Ltd.). The resulting mixture was stirred to provide a solution of a semi-conducting resin composition.

The semi-conducting resin composition was coated on the surface of the insulating cover layer including the terminal portion of a suspension board with circuit, which is the same as used in Example 1, by using a bar coater, dried at 100° C. for 5 minutes, and further dried at 180° C. for 15 minutes, thereby forming a semi-conducting layer with a thickness of 2 μm.

Subsequently, the same process steps as performed in Example 1 were performed, whereby the suspension board with circuit in which the semi-conducting layer was formed on the surface of the insulating cover layer except for that of the terminal portion was obtained.

The initial surface resistivity of the semi-conducting layer was 8.3×10⁷ Ω/□.

### Synthetic Example 1 (Synthesis of Polyamic Acid Resin A)

After 27.6 g (0.25 mol) of p-phenylenediamine and 9.0 g (0.05 mol) of 4,4′-diaminodiphenyl ether were placed in a 1-L separable flask, 767 g of N-methyl-2-pyrrolidone (NMP) was added thereto and stirred so that p-phenylenediamine and 4,4′-diaminodiphenyl ether were dissolved therein.

Then, 88.3 g (0.3 mol) of 3,3′,4,4′-biphenyltetracarboxylic dianhydride was added gradually to the resulting solution and stirred continuously at a temperature of 30° C. or less for 2 hours to provide a solution of a polyamic acid resin A at a concentration of 14% by weight. The viscosity of the solution of the polyamic acid resin A at 30° C. was 500 Pa·s.

### Synthetic Example 2 (Synthesis of Polyamic Acid Resin B)

After 27.6 g (0.25 mol) of p-phenylenediamine and 13.1 g (0.05 mol) of 1,3-bis(4-aminophenoxy) benzene (APB) were placed in a 1-L separable flask, 792 g of NMP was added thereto and stirred so that p-phenylenediamine and APB were dissolved therein.

Then, 88.3 g (0.3 mol) of 3,3′,4,4′-biphenyltetracarboxylic dianhydride was added gradually to the resulting solution and stirred continuously at a temperature of 30° C. or less for 2 hours to provide a solution of a polyamic acid resin B at a concentration of 14% by weight. The viscosity of the solution of the polyamic acid resin B at 30° C. was 400 Pa·s.

### Example 4

After a sensitizer (37.5 g of nifedipine and 25.0 g of an acetylated compound) was added to the solution of the polyamic acid resin A obtained in Synthetic Example 1, 374.7 g of a 10 wt % NMP dispersion of carbon black (Special Black4™ commercially available from Degussa Japan, Ltd.) was further added thereto. The resulting mixture was stirred to provide a photosensitive semi-conducting resin composition containing the carbon black evenly dispersed therein.

The photosensitive semi-conducting resin composition was coated on the surface of the insulating cover layer including the terminal portion of a suspension board with circuit, which is the same as used in Example 1, by using a spin coater and dried at 90° C. for 15 minutes to form a coating with a thickness of 4 μm (see FIG. 2(b)).

Then, the coating was exposed to ultraviolet light at a dose of 700 mJ/cm² through a photo-mask (see FIG. 2(c)), heated at 190° C. for 10 minutes after the exposure, and developed to be patterned with a negative image (see FIG. 2(d)).

Thereafter, the patterned coating was heated at 385° C. under reduced pressure at 1.33 Pa to be imidized, whereby the suspension board with circuit in which the semi-conducting layer was formed on the surface of the insulating cover layer except for that of the terminal portion was obtained (see FIG. 2(e)).

The initial surface resistivity of the semi-conducting layer was 7.0×10⁷ Ω/□.

### Example 5

After a sensitizer (38.7 g of nifedipine and 25.8 g of an acetylated compound) was added to the solution of the polyamic acid resin B obtained in Synthetic Example 2, 376.3 g of a 12 wt % NMP dispersion of carbon black (Special Black4™ commercially available from Degussa Japan, Ltd.) was further added thereto. The resulting mixture was stirred to provide a photosensitive semi-conducting resin composition containing the carbon black evenly dispersed therein.

Subsequently, by using the photosensitive semi-conducting resin composition, the suspension board with circuit in which the semi-conducting layer was formed on the surface of the insulating cover layer except for that of the terminal portion was obtained in accordance with the same method as implemented in Example 4.

The initial surface resistivity of the semi-conducting layer was 3.0×10⁸ Ω/□.

### Example 6

After a sensitizer (6.2 g of nifedipine and 31.2 g of polyethylene glycol) was added to the solution of the polyamic acid resin A obtained in Synthetic Example 1, 218.6 g of a 4 wt % NMP dispersion of carbon black (KETJENBLACK™ commercially available from Lion Corporation) was further added thereto. The resulting mixture was stirred to provide a photosensitive semi-conducting resin composition containing the carbon black evenly dispersed therein.

Subsequently, by using the photosensitive semi-conducting resin composition, the suspension board with circuit in which the semi-conducting layer was formed on the surface of the insulating cover layer except for that of the terminal portion was obtained in accordance with the same method as implemented in Example 4.

The initial surface resistivity of the semi-conducting layer was 6.0×10⁷ Ω/□.

### Example 7

After a sensitizer (37.5 g of nifedipine and 25.0 g of an acetylated compound) was added to the solution of the polyamic acid resin A obtained in Synthetic Example 1, 281.0 g of a 4 wt % NMP dispersion of a carbon nanofiber (VGCF™ commercially available from Showa Denko K.K.) was further added thereto. The resulting mixture was stirred to provide a photosensitive semi-conducting resin composition containing the carbon nanofiber evenly dispersed therein.

The photosensitive semi-conducting resin composition was coated on the surface of the insulating cover layer including the terminal portion of a suspension board with circuit, which is the same as used in Example 1, by using a spin coater and heated at 90° C. for 15 minutes to form a coating with a thickness of 4 μm (see FIG. 2(b)).

Then, the coating was exposed to ultraviolet light at a dose of 700 mJ/cm² through a photo-mask (see FIG. 2(c)), heated at 190° C. for 10 minutes after the exposure, and developed to be patterned with a negative image (see FIG. 2(d)).

Thereafter, the patterned coating was heated at 385° C. under reduced pressure at 1.33 Pa to be imidized, whereby the suspension board with circuit in which the semi-conducting layer was formed on the surface of the insulating cover layer except for that of the terminal portion was obtained (see FIG. 2(e)).

The initial surface resistivity of the semi-conducting layer was 4.0×10⁶ Ω/□.

### Example 8

After a sensitizer (38.7 g of nifedipine and 25.0 g of an acetylated compound) was added to the solution of the polyamic acid resin B obtained in Synthetic Example 2, 290.1 g of a 4 wt % NMP dispersion of a carbon nanofiber (VGCF-H™ commercially available from Showa Denko K.K.) was further added thereto. The resulting mixture was stirred to provide a photosensitive semi-conducting resin composition containing the carbon nanofiber evenly dispersed therein.

The photosensitive semi-conducting resin composition was coated on the surface of the insulating cover layer including the terminal portion of a suspension board with circuit, which is the same as used in Example 1, by using a spin coater and heated at 90° C. for 15 minutes to form a coating with a thickness of 4 μm (see FIG. 2(b)).

Then, the coating was exposed to ultraviolet light at a dose of 700 mJ/cm² through a photo-mask (see FIG. 2(c)), heated at 190° C. for 10 minutes after the exposure, and developed to be patterned with a negative image (see FIG. 2(d)).

Thereafter, the patterned coating was heated at 385° C. under reduced pressure at 1.33 Pa to be imidized, whereby the suspension board with circuit in which the semi-conducting layer was formed on the surface of the insulating cover layer except for that of the terminal portion was obtained (see FIG. 2(e)).

The initial surface resistivity of the semi-conducting layer was 3.5×10⁸ Ω/□.

### Comparative Example 1

After 500 mL of a 0.1M aqueous potassium peroxodisulfate solution was placed in a 1-L glass beaker and held at 2 to 3° C., a suspension board with circuit, which is the same as used in Example 1, was immersed in the solution.

Subsequently, 100 mL of a 0.2 M aqueous pyrrole solution was added to the solution. The resulting mixture was stirred continuously for 10 minutes, while it was held at 15° C., so that pyrrole was polymerized. As a result, a semi-conducting layer composed of polypyrrole was formed on the surface of the suspension board with circuit. Since the polypyrrole had an inferior wettability relative to each of the terminal portion and the metal supporting board (metal surface), the semi-conducting layer was not formed on the terminal portion and was formed only on the surface of the insulating cover layer.

The initial surface resistivity of the semi-conducting layer was 1.0×10⁶ Ω/□.

### EVALUATION

The individual suspension boards with circuit obtained in Examples 1 to 8 and Comparative Example 1 were subjected to in-water ultrasonic cleaning (which was performed at 50 kHz and 25° C. for 10 minutes). As a result, the surface resistivity varied slightly in each of Examples 1 to 8, while the surface resistivity varied greatly in Comparative Example 1, as shown in Table 1.

TABLE 1

| | | | | | | | | | Compara- |
|---|---|---|---|---|---|---|---|---|---|
| | | | | | | | | | tive |
| | Exam- | Exam- | Exam- | Exam- | Exam- | Exam- | Exam- | Exam- | Example |
| | ple 1 | ple 2 | ple 3 | ple 4 | ple 5 | ple 6 | ple 7 | ple 8 | 1 |
| Initial | 2.6 × 10⁸ | 2.9 × 10⁶ | 8.3 × 10⁷ | 7.0 × 10⁷ | 3.8 × 10⁸ | 6.0 × 10⁷ | 4.0 × 10⁶ | 3.5 × 10⁸ | 1.0 × 10⁶ |
| Surface | | | | | | | | | |
| Resistivity | | | | | | | | | |
| (Ω/□) | | | | | | | | | |
| Surface | 1.7 × 10⁸ | 2.3 × 10⁶ | 1.5 × 10⁸ | 5.7 × 10⁷ | 5.1 × 10⁸ | 6.5 × 10⁷ | 5.1 × 10⁶ | 5.2 × 10⁸ | 1.0 × 10⁸ |
| Resistivity | | | | | | | | | |
| After | | | | | | | | | |
| Ultrasonic | | | | | | | | | |
| Cleaning | | | | | | | | | |
| (Ω/□) | | | | | | | | | |

While the illustrative embodiments of the present invention are provided in the above description, such is for illustrative purpose only and it is not to be construed restrictively. Modification and variation of the present invention that will be obvious to those skilled in the art is to be covered by the following claims.

What is claimed is:

1. A semi-conducting resin composition comprising an imide resin or a precursor of an imide resin, a conducting particle, and a solvent.

2. A semi-conducting resin composition according to claim 1, wherein the conducting particle is at least one selected from the group consisting of a carbon black particle, a carbon nanofiber, and a metal oxide particle.

3. A semi-conducting resin composition according to claim 1, further comprising a sensitizer.

4. A wired circuit board comprising:
a conductive layer;
an insulating layer adjacent to the conductive layer; and
a semi-conducting layer composed of a semi-conducting resin composition comprising an imide resin or a precursor of an imide resin, a conducting particle, and a solvent, the semi-conducting layer being formed on a surface of the insulating layer.
